(19) United States
(12) Patent Application Publication
(10) Pub. No.: US 2008/0142507 A1
(43) Pub. Date: Jun. 19, 2008

(54) Method for controlling an apparatus having electric heating

(75) Inventors: Uwe Has, Unterneukirchen (DE); Scott Truitt, Powell, TN (US)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Home Appliances Corporation, Huntington Beach, CA (US)

(21) Appl. No.: 11/641,373

(22) Filed: Dec. 18, 2006

(51) Int. Cl. B23K 13/08

(52) U.S. Cl. 219/482

(57) ABSTRACT

A procedure to the control of a device with an electric heating, especially a cooking device with a cooking chamber and or a cook area, that shows at least two switch apparatus to the divided on and switching off of an electric voltage supply of the heating and cyclically actuated temperature control of the heating. At the same time both switch apparatus are used alternating and or in periodic time intervals.

### BACKGROUND OF THE INVENTION

The invention relates to a method for controlling a device with electric heating, especially a cooking device with a cooking chamber and or a cook area, as well as such a device.

Electric cooking devices often comprise a main switch, with which a power supply can be turned on and disengaged for one electrically heatable cooking chamber and or for heatable cook areas. The main switch is usually at a device's front at a well accessible place. For security reasons, the total current necessary for the heating of the cooking chamber does not flow normally by the switch at the device's front, but rather the front of the device controls an electromagnetic or electronic relay so that through the switch only a slight current flows. The relay can switch through substantially higher currents and is connected in appropriate manner directly in the corresponding connector.

The desired temperature in the cooking chamber and/or at the selected cook areas is mainly set via a switch or the like, at the devices front, that influence a control. This provides, in conventional cooking devices, depending upon the selected temperature and the sensor signals of a temperature sensor, for an increase in the electric heating of the cooking chamber and/or the cook areas. This increase in heating is controlled characteristically through a relay that turns on and turns off the power supply for the electric heating in short time intervals, in order to hold the desired temperature.

For security reasons, cooking devices are separated from all-pole networks with relays, i.e. in every conductor a relay is arranged whose contacts are opened with a disengaged heating element. Both mentioned relays are switched in series because both should be in the situation to turn on the voltage supply of the heating and to disengage the same.

### SUMMARY OF THE INVENTION

The existing invention provides a simple and dependable control of an electric cooking device that distinguishes itself especially through a large longevity and robustness and for which, if possible, no additional components are required.

With the present invention, the service life of a circuit relay clearly can be increased, for the reason that two switched in series relays not only are burdened a with a high number by switch cycles, but rather these switch cycles are typically distributed over the devices service life, if possible, uniformly among both relays. It turns out that, in the normal course, the wear on such relays depends significantly of the amount of the therewith released switch process. When configured as a main switch as well as a cyclically actuated switch to the temperature control of an electric heating, the service life of the cyclically actuated relay clearly can be increased by an alternating activation between the two switched in series relays. In the ideal case, a strong equalization of the service life of both relays can be reached. With the invention, the security determination can be kept on the one hand that in turned off device an all pole network separation exists. On the other hand a clear increase of the loss security and standing stability of the device can be reached without adding by additional components because the of service life to be expected characteristically at least the cyclically actuated relay responsible for the temperature control clearly is increased.

Both relays functioning as switch apparatus can be shifted after a certain number by actuations, or after certain given time intervals in its function. This switch can follow also after a given number of switch processes, which thus best takes into account the corresponding mechanical load to which the relay is subjected. The main power supply can be engaged and disengaged with the respective other switch apparatus that are not used for the temperature control, i.e. that not are cyclically actuated. In closed switch apparatus to the electric power supply of the heating of the cooking chamber and/or one or several cook areas, the respective other switch apparatus is opened and closed corresponding to the temperature control, i.e. cyclically actuated.

Both switch apparatus are configured preferably as controllable electromagnetic relays that are subject to a mechanical wear that depends in first line by the turned loads as well as on the amount of the switch process. Because the loads turned with the relays in the existing application remain extensive constant, the wear can be diminished by the amount appearing during the typical product life of the cooking device of the switch process.

### BRIEF DESCRIPTION OF THE DRAWINGS

The invention is more closely explained with reference to an embodiment and to the enclosed drawings as follows:

FIG. 1 is a schematic view of a first variant of a cooking device.

### DETAILED DESCRIPTION OF THE PREFERRED EMBODIMENT

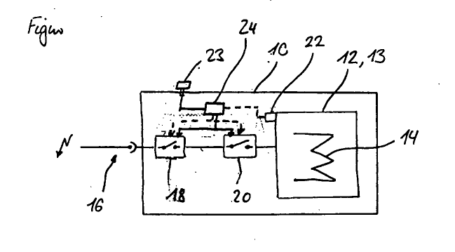

FIG. 1 shows a schematic view of an invention appropriate for cooking device 10 that controls a cyclically actuated temperature control of an electric heating device 14 of an cooking chamber 12 and or at least a cook area 13. That cooking devices 10 shows a connection to an electric voltage provision 16. This voltage provision 16 places usually a change voltage planned for households by, respectively, 110 or 220 volts and a frequency of 50 and/or 60 Hertz to the decree.

The invention appropriate for cooking device further includes two switches in series apparatus 18, 20 that connect the electric voltage provision 16 with the electric heating 14. Both switch apparatus 18, 20 are configured preferably as a relay. The one switch apparatus offers at the same time to that and switching off of the voltage provision of the total electric cooking device. The other switch apparatus serves as the temperature control of the electric heating to turn on preferably through short interval successive on and off cycling. The respective function is shown with both switch apparatus 18, 20 through a switch 24, that is connected with both switches 18, 20. The switch 24 is connected again with a switch 23 that can be at a device's front, with which turning on and disengaging of the total electric device 10 is controlled. The switch 24 is connected further to a temperature sensor 22, which senses the temperature that the switch apparatus seeks to make approach a selected desired temperature of the cooking chamber and/or the dialed hot plate to be cyclically turned on and off. The cycling results are dependent upon the exit signals of the temperature sensor 22 that compares the selected temperature with the actual temperature and delivers corresponding cycle signals in dependence therefrom at the switch 24.

In accordance with the invention, the functions are exchanged between both relays 18, 20 in certain cycles by means of the switch 24. As indicated by the interrupted line in FIG. 1, the exit signals of the temperature sensor 22 and the switch 24 mutually control the first relay 18 and the second relay 20. The criteria for this switch can be, for example, a certain useful life or a certain number of switch processes. A simple switch can also be provided such that, after every turning on of the cooking device 10, a respectively another relay is cyclically actuated. The non-cyclically actuated relay represents the on and off switch for an electric voltage supply 16, whereby, an all pole network delimited by security reasons can be configured.

The invention appropriately distributes the natural wear of the switch contacts of both relays 18 and 20 and prevents extensively the premature wear of the cyclically actuated relay. In particular in connection with an exchange after a predetermined number of switch processes, the load responsible for the wear of the relays is distributed relatively uniformly among both switches.

For a larger number of heating elements in a cook area 13, several second relays 20 can be planned as indicated in FIG. 1. These become, in accordance with the invention, cyclic cyclically actuated and/or as a switch on relays, the connection and/or interruption with the central voltage provision 16 is used.

The electric heating 14 is equipped in the configuration shown in FIG. 1 with a second heating element 15, that can be located in a cook area or, respectively, in an external ring zone. For these second heating elements 15, a further conductor with a third relay 21 is planned, that provides in disengaged device for an allpolige network separation. In a turned on device, all three switch on relays 18, 20 are cyclically actuated—that is, the switches are actuated in a pulsed or phased manner.

1. A method for controlling of a device with an electric heating, especially a cooking device with a Cooking chamber comprising:
two switch apparatus separated from one another and operable to switch off of an electric voltage supply of the heating and a cyclically actuated achievement control of the heating, marked, in that both switch apparatus alternately to that on and switching off of the electric voltage provision and the achievement control.

2. The method according to claim 1, wherein the function of both switch apparatus is cyclically exchanged in periodic time intervals and/or after a given number by switch processes and/or after every turning on of the device.

3. A device with electric heating, especially a cooking device with one electrically heatable cooking chamber and or with a heatable cook area, comprising:
at least two switch apparatus separated form one another and operable to switch off an electric voltage supply of the device and a cyclically actuated control of the electric heating, the pair of switch apparatus being alternately operated to control the heating temperature of the heating element.

4. The device according to claim 3, wherein the switch apparatus are cyclically operated at periodic time intervals and/or in dependence upon a given number of switch processes and/or after every switching on.

5. The device according to claim 3, wherein both switch apparatus are configured as electromagnetic relays.
